(19) United States
(12) Patent Application Publication
(10) Pub. No.: US 2024/0138324 A1
(43) Pub. Date: May 2, 2024

(54) Habbag Hemwoo Geotextile Fabric System

(71) Applicants: Jean-Michel Libeau, Wanaka (NZ); Sarah Elizabeth Johnston, Oxford (NZ)

(72) Inventors: Jean-Michel Libeau, Wanaka (NZ); Sarah Elizabeth Johnston, Oxford (NZ)

(21) Appl. No.: 18/052,157

(22) Filed: Nov. 2, 2022

(51) Int. Cl. A01G 13/02; D04H 1/425; D04H 1/4266; D04H 1/4382; D06M 13/224

(52) U.S. Cl. CPC A01G 13/0268; D04H 1/425; D04H 1/4266; D04H 1/43835; D06M 13/224; D06M 2101/02; D10B 2505/204

(57) ABSTRACT

The invention relates to a non-woven textile fabric of one or a combination of hemp, wool, cotton, cellulose and or other natural fibre, treated with a natural water proofing, air permeable and fungicide solution for geotextile fabrics. The geotextile fabric encourages a more fibrous root system within the plants root zone in the soil improving moisture and air movement while improving soil microbial life which assists with the plants fibrous root structure reducing soil erosion and improving plant survival. The fabric can be directly placed onto the ground and biodegrades over a period of years.

### TECHNICAL FIELD

The invention relates to natural fibre geotextile fabric used in the Roading & Construction, Landscaping, Nursery and Horticultural industries.

### BACKGROUND OF THE INVENTION

It is known that geotextile fabrics are extensively used in the Roading & Construction, Landscaping, Nursery and Horticultural industries. for the land erosion control, weed suppression and soil moisture management. These fabrics are traditionally made from synthetic man-made fibres and materials which are now a significant environmental problem because they are non-recyclable and are an environmental issue due to micro plastics being released into the environment.

This natural fibre technology has led to the development of new fabrics with the application of a natural water-resistant air permeable material for use in these fabrics to extend fabric application life. The fabric creates additional benefits of being biodegradable and provides the additional benefit of protecting plant root system. The applicants have discovered that when the plant roots grow under the fabric, they have a superior root soil microbial interaction because of air and moisture movement through the natural fibre fabric. This causes the plant to produce a more fibrous root system leading to better plant survival. The fabric also encourages a more fibrous root system within the plants root zone because of the moisture and Air movement improving soil microbial life.

It is therefore an objective of the invention to provide a system for producing fabrics having different fibre structures and natural water resistant and air permeability, or to at least provide a useful alternative to existing geotextile systems

### SUMMARY OF THE INVENTION

Using a non-woven fabric comprising of one or a combination of hemp, wool, cotton, cellulose and or other natural fibres to specified fibre percentages, fabric weights and density for the construction of geotextile and plant bag-pot fabrics. To enable the fabric to withstand the requirements within the environment, a natural water repellent, air permeable and fungicide solution is applied to the fabric.

### BRIEF DESCRIPTION OF THE FIGURES

Preferred embodiments of the invention will be described by way of example only and with reference to the photos, in which:

FIG. 1 is the geotextile Wool and Hemp/lyocell fabric

FIG. 2 is the Wool and Hemp/lyocell fabric treated with the natural water repellent, air permeable, fungicide solution

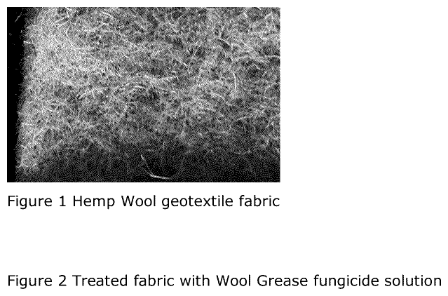

### DETAILED DESCRIPTION

The invention relates to a natural fiber geotextile non-woven fabric for use Roading & Construction, Landscaping, Nursery and Horticultural industries.

The fabric is configured to set percentages of staple fibres blended and formed into a non-woven fabric from 250-2000 gsm (grams per square meter) during the needle punching process and Air laid web formation.

The staple fibres may be short staple fibres or long staple fibres. The staple fibres may include, but are not limited to cotton, wool, hemp, cellulose and or other natural fibres.

The water proofing solution is configured from at least two natural materials.

The water proofing solution may be wool grease, vegetable plant-based oils and a natural fungicide but are not limited to being Copper Sulphate or Sulphur.

This water proofing solution will be applied to the non-woven fabric by a textile Padding System and the excess solution removed by Mangle rollers. The fabric passes through the application process applying a set amount of solution to provide water, fungal resistance, and air permeability to the non-woven fabric.

The fabric is used for geotextile and plant bag-pot applications of Roading & Construction, Landscaping, Nursery and Horticultural industries. The fabric construction and solution enable the plants roots to have a superior root soil microbial interaction because of air and moisture movement through the natural fibre fabric. This encourages a more fibrous root system within the plants root zone because of the moisture and air movement improving soil microbial life which assist with the plant sending out multiple new roots, creating a more fibrous root system leading to better plant survival.

1. Combining natural fibers of one or a combination of hemp, wool, cotton, cellulose and or other natural fibers at set percentages to produce a non-woven fabric that is used for the manufacturing of geotextiles.

2. Application of a water proofing solution made from wool grease and or natural oils and natural fungicides, extends the life of the wool hemp cellulose fabric in the fabrics end use environment.

3. The fabric according to claims 1 and 2 where in the first and second process combined to form the finished fabric for geotextile use.

4. The fabric according to claims 1 and 2 where in the first and second process combined to form a suitable fabric for water, fungal resistance, and air permeability of a non-woven fabric.

5. The natural fabric according to claims 1 and 2 encourages a more fibrous root system within the plants root zone because of the improved moisture and air movement improving soil microbial life which assist with the plant fibrous root structure.

6. The natural geotextile fabric according to claims 1, 2 and 5 mean that soil erosion is significantly reduced because of the major improvement in the root zone area of the plant.

7. The natural fiber geotextile fabric, placed directly onto the ground around the plant, enables superior root growth and plant establishment.

8. The geotextile fabric according to claims 1 and 2 made of natural materials biodegrade over a period of time on the ground surface becoming an organic material.

9. As the geotextile fabric biodegrades over a period of time it releases nutrients into the soil and growing plants. Examples of these; nitrogen, Sulphur, sodium, potassium, phosphorus, magnesium and calcium. These nutrients are naturally released into the soil over time and are essential for healthy plant growth.
